(19) United States
(12) Patent Application Publication
(10) Pub. No.: US 2015/0114960 A1
(43) Pub. Date: Apr. 30, 2015

(54) DUST COVER FOR CAPLESS FUEL FILLER SYSTEM

(71) Applicant: ALL SALES MANUFACTURING, INC., EL DORADO HILLS, CA (US)

(72) Inventors: Steven A. DRINGENBERG, Camino, CA (US); Timothy D. Manning, SR., Cameron Park, CA (US)

(73) Assignee: ALL SALES MANUFACTURING, INC., EL DORADO HILLS, CA (US)

(21) Appl. No.: 14/064,440

(22) Filed: Oct. 28, 2013

(51) Int. Cl. B60K 15/04

(52) U.S. Cl. CPC B60K 15/04
USPC 220/86.2

(57) ABSTRACT

A capless fuel filler system that receives a nozzle includes a fuel spout, a deflectable latch carried by the fuel spout, a spring-loaded flapper valve and linkage connected between the latch and the spring-loaded flapper valve. The nozzle is received in the fuel spout and engages the deflectable latch to allow the spring-loaded flapper valve to be deflected by the nozzle. The system also includes a cover carried by the fuel spout, wherein removal of the cover allows receipt of the nozzle in the fuel spout.

### TECHNICAL FIELD

Generally, the present invention is directed to a covering device for a capless fuel filler system. Specifically, the present invention is directed to a cover that prevents dust or other contaminants from entering a capless fuel filler system for an automobile or other fuel-operated mechanism.

### BACKGROUND ART

It is well known that screw caps are used to cover a nozzle entry into gas tanks which carry fuel for motorized vehicles. Such screw caps have internal threads that mate with corresponding threads associated with a fuel spout that leads to the gas tank. One shortcoming of screw cap gas tanks is that they are unable to prevent theft and gasoline from the tank. Capless fuel filler systems have been developed to prevent theft of gasoline while still allowing for normal fill procedures to be utilized. Although key systems have also been developed for use with screw caps to prevent theft of fuel, these systems are not convenient to operate, especially if one forgets the key to open the gas tank door.

One known capless fuel filler system utilizes a spring-loaded flapper valve which is held closed by latches that can only be released by entry of a standard-size fuel nozzle into the fuel spout. Such a system eliminates the need for a fuel tank screw cap. In operation, when a proper nozzle is inserted into the nozzle entry of the system, the latches are released and the nozzle pushes the spring-loaded flapper valve to an open position. When the nozzle is removed the flapper valve is automatically forced closed by the associated spring and the latches are re-engaged.

Although the capless fuel systems are effective in their stated purpose, problems have arisen in their operation. Some vehicles, especially pick-up trucks and other vehicles used in farming, off-site construction and in other remote areas, operate in a dusty environment. As a result, moisture, dust and other contaminants accumulate in and around the opening of the capless system and especially in the nozzle entry area and above the flapper valve. Accordingly, when a filling nozzle is inserted, the contaminants migrate into the fuel spout, through the flapper valve and, accordingly, and into the fuel tank. These contaminants are later transferred into the fuel system and can cause problems in the operation of the engine. One attempt at overcoming this problem is the use of a plug. However, the inside surfaces of the spout damage the exterior of the plug and form exterior gaps, which then still allows dust to accumulate on the flapper valve. Use of the plug may also engage the latches which, over time, may prematurely disable the flapper valve and allow the fuel to evaporate into the environment. Therefore, there is a need in the art to prevent such contaminants from accumulating around the entry into the capless fuel system. And there is a need to prevent contaminants from entering without damaging the fuel filler system.

### SUMMARY OF THE INVENTION

In light of the foregoing, it is a first aspect of the present invention to provide a dust cover for capless fuel filler system.

It is another aspect of the present invention to provide a capless fuel filler system that receives a nozzle comprising a fuel spout, a deflectable latch carried by the fuel spout, a spring-loaded flapper valve, linkage connected between the latch and the spring-loaded flapper valve, wherein the nozzle is receivable in the fuel spout and engages the deflectable latch to allow the spring-loaded flapper valve to be deflected by the nozzle, and a cover carried by the fuel spout, wherein removal of the cover allows receipt of the nozzle in the fuel spout.

### BRIEF DESCRIPTION OF THE DRAWINGS

This and other features and advantages of the present invention will become better understood with regard to the following description, appended claims, and accompanying drawings wherein:

FIG. 1 is a perspective view showing an exterior of a capless fuel filler system;

FIG. 2 is a perspective cross-sectional view of the capless fuel filler system utilized according to the concepts of the present invention;

FIG. 3 is a partial cross-sectional view of a dust cover utilized in the capless fuel filler system according to the concepts of the present invention;

FIG. 4 is a perspective view of the dust cover shown in FIG. 3;

FIG. 5 is an alternative embodiment of a dust cover for a capless fuel filler system according to the concepts of the present invention; and

FIG. 6 is a perspective view of the dust cover installed on the capless fuel filler system according to the concepts of the present invention.

### BEST MODE FOR CARRYING OUT THE INVENTION

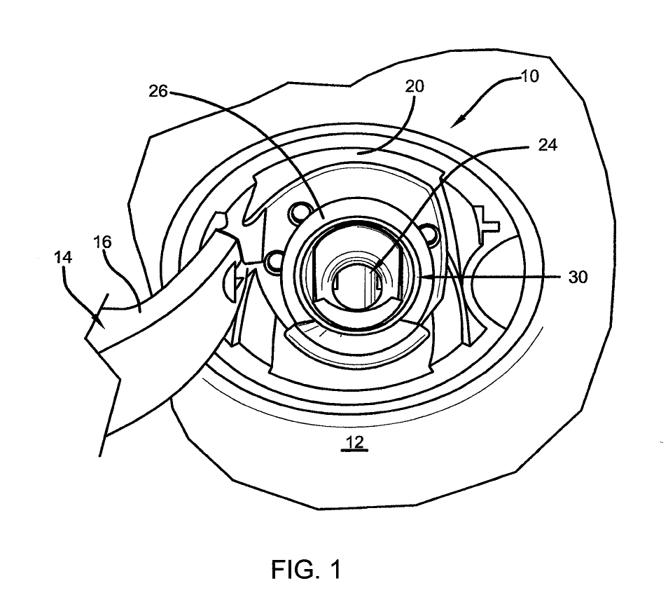

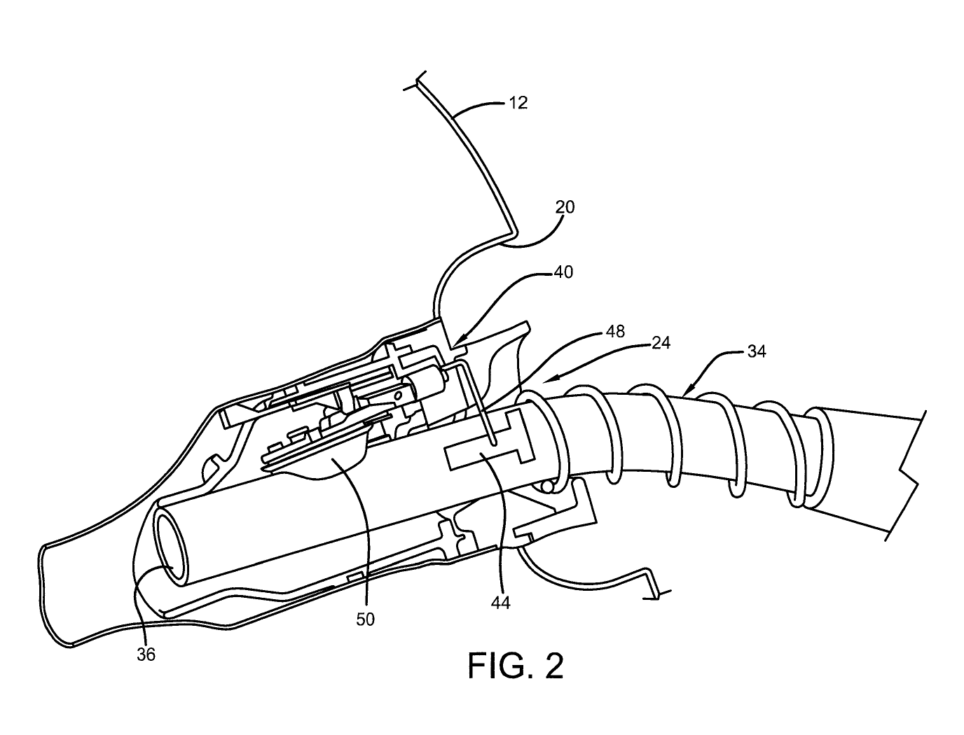

Referring now to the drawings, and in particular to FIGS. 1 and 2, it can be seen that a capless fuel filler system is designated generally by the numeral 10. The system 10 is utilized with motorized vehicles that require liquid fuel, such as gasoline or the like. A body panel 12 carries the fuel filler system 10 and a fuel door cover 14 covers the fuel filler system in a conventional manner. The cover 14 provides a hinge 16 that is received within the body panel so as to allow for the cover to enclose the fuel filler system in an aesthetic manner. In other words, the fuel door cover 14 precludes entry of large contaminants and provides for a pleasing appearance to the vehicle. However, the cover 14 does not provide an effective sealing of the capless fuel filler system. In any event, a shroud 20 is inset or recessed from the body panel 12 and carries a fuel spout 24 which leads to a fuel tank that carries the gasoline or other fuel utilized by the vehicle. In some embodiments, an indicia collar 26 is mounted to surround or partially surround the fuel spout 24. The indicia collar 26 may contain information as to the type of fuel that is allowed to be deposited into the fuel tank, safety information or other rating information.

As best seen in FIG. 2, the fuel spout 24 receives a nozzle 34 which transfers the fuel from a filling station into the fuel tank of the vehicle. The nozzle 34 has an end 36 which is received in a nozzle reception mechanism 40 carried by the shroud 20. The nozzle reception mechanism includes a latch 44 (only one shown) which is deflected by the nozzle end 36 when inserted into the fuel filler system. A link 48 connects to the latch 44 at one end and is coupled to a spring-loaded flapper valve 50 at an opposite end. As previously described in the Background Art, engagement of the nozzle with the latches allows for opening of the spring-loaded flapper valve. When an appropriate nozzle is inserted into the fuel spout 24, the latches 44 release and the nozzle is allowed to push the spring-loaded flapper valve to an open position. An inappropriately sized nozzle is unable to properly engage the latches and, as a result, the flapper valve is unable to be opened. In any event, once the nozzle is fully inserted, a pump may then be actuated and the fuel is transferred into the gas tank associated with the fuel filler system. When the nozzle is removed the flapper valve is automatically forced closed by the spring-loaded mechanism and the latches are re-engaged.

As mentioned in the Background Art, contaminants accumulate in the area of the fuel spout 24 and on an exterior closing surface of the flapper valve 50. Accordingly, when the flapper valve is moved to an open position, any contaminants accumulated in that area are allowed to flow further along the fuel spout and migrate into the fuel tank with the dispensed fuel.

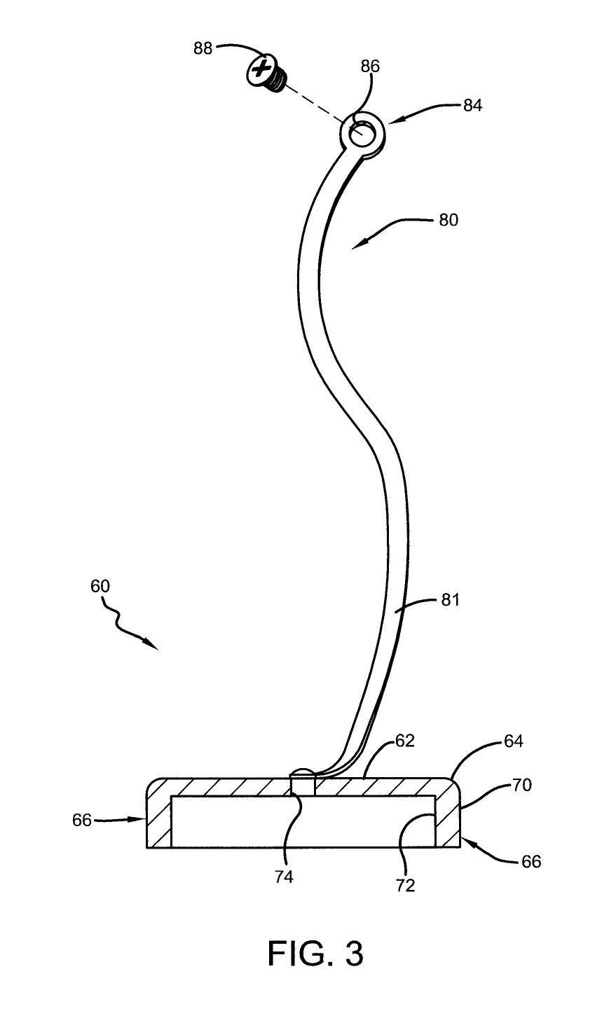

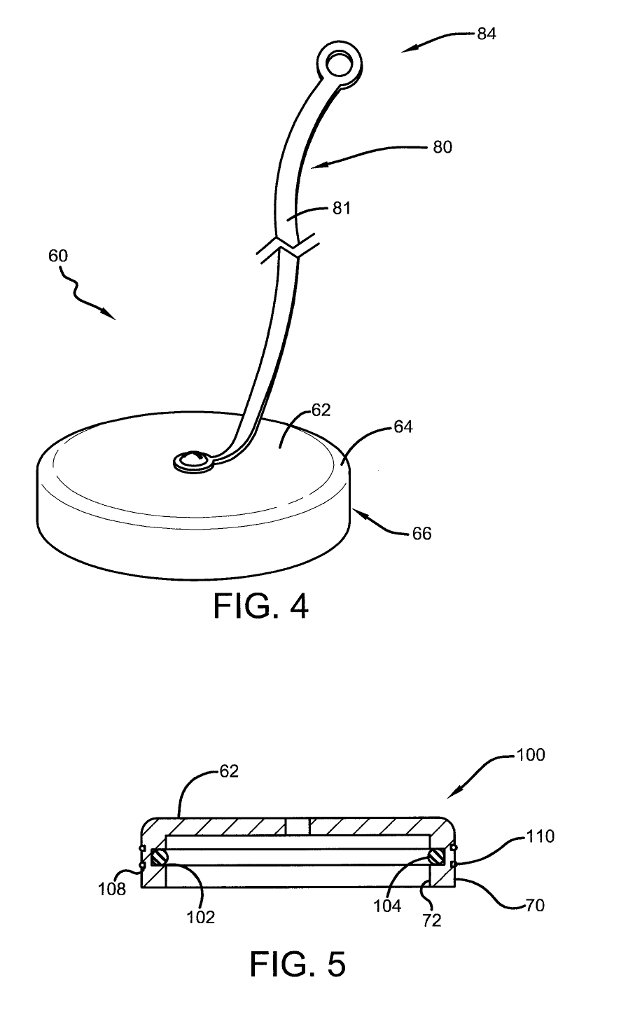

Referring now to FIGS. 3-6, it can be seen that a dust cover is designated generally by the numeral 60. The cover 60 includes a body 62 which, in most embodiments, is a circular construction. However, skilled artisans will appreciate that the body 62 may be appropriately shaped so as to fit a particular configuration of a fuel spout. In any event, in the present embodiment the cover 60 is of a circular configuration and provides an outer periphery 64. Axially extending from the periphery 64 is a flange 66. The flange 66 provides for an external surface 70 which generally matches the outer periphery 64. The flange also provides an internal surface 72 substantially opposite the external surface 70.

The body 62 may provide an opening 74 therethrough or a protuberance of some type.

As part of the dust cover 60, a tether designated generally the numeral 80 may be provided. The tether 80 includes a flexible member 81 which has at one end a cap end 82. This end 82 is secured at the opening 74 or protuberance and provides a secure permanent attachment thereto. At an opposite end of the member 81 is an attachment eyelet 84 which has an eyelet opening 86 extending therethrough. A fastener 88 is inserted into the eyelet opening 86 and allows for securement of the tether 80 to the shroud 20. As a result, the tether maintains the dust cover 60 in a secured relationship with the shroud and the vehicle so that the dust cover is not easily lost.

The dust cover 60 is installed over the fuel spout 24. In particular, the flange 66 thickness, sized between the external surface 70 and internal surface 72, fits in the gap 30. In other words, the flange 66 has a thickness that is less than the width of the gap 30. This provides a relatively secure covering of the fuel spout so as to prevent the contaminants from entering the area from the fuel spout opening to the outer surface of the flapper 50. As a result, with the dust cover installed, the spout 24 is effectively sealed so as to prevent contaminants from entering area above the flapper valve. In any event, the cap is removed by either pulling on the tether or grasping and lifting the outer periphery 64 so as to expose the fuel spout 24 and the flapper valve 50. The user can then insert the nozzle 34 and fill their fuel tank as is commonly done. Upon completion of the fueling process, the user re-installs the dust cover 60 over the spout 24.

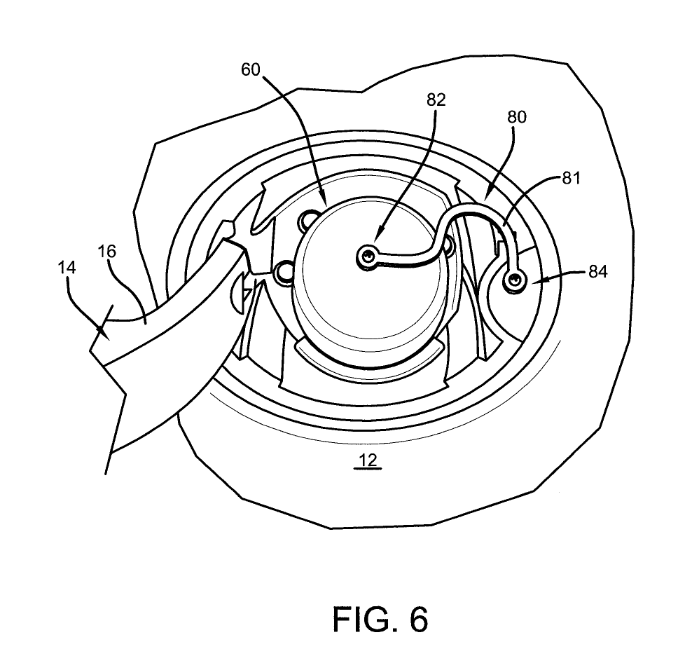

Referring now to FIG. 5, another embodiment of the dust cover is presented. In this embodiment, an alternative dust cover is designated generally by the numeral 100. The cover 100 is constructed in a similar manner as the cover 60, but is provided with additional features to facilitate operation thereof. In particular, the cover 100 provides an internal surface 72 which includes an internal groove 102. Received within the groove 102 is an O-ring 104 which is typically made of a rubber or other polymeric material. The cover 100 also provides the external surface 70 with at least one external groove 108. Received within each external groove 108 is an external O-ring 110. These rings 110 provide a gripping surface so as to allow the user to better grasp the cover 100 to assist in its removal. In some embodiments, the external grooves 108 and external O-rings 110 may be replaced with a rigid extension of the external surface. As such, the user will still be able to grasp an outer surface of the cover to assist in its removal.

Referring now to FIG. 6, it can be seen that the cover is placed over the fuel spout in between the outer periphery of the fuel spout and the inner periphery of the indicia collar. It will be appreciated that in some embodiments the indicia collar may not be provided and the cover 60 or 100 still operates so as to securely seal the fuel spout and prevent contaminants from entering. Skilled artisans will appreciate that the cover 60 and 100 is effective to seal capless automotive fuel systems at the refueling opening point so as to prohibit foreign materials such as dirt, dust, rocks, moisture and the like from entering the fuel system at that point. The covers 60 or 100 are easily installed and easily operate and prevent damage to the vehicle's fuel system and/or engine. The covers 60 and 100 may be constructed from a metal, such as aluminum, or from a polymeric material. The covers 60 and 100 are also advantageous in that they do not come in contact with any of the internal components of the fuel filler system. In other words, the covers never interfere with or engage the nozzle reception mechanism 40.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby.

Accordingly, for an appreciation of the true scope and breadth of the invention, reference should be made to the following claims.

What is claimed is:

1. A capless fuel filler system that receives a nozzle comprising:
a fuel spout;
a deflectable latch carried by said fuel spout;
a spring-loaded flapper valve;
linkage connected between said latch and said spring-loaded flapper valve, wherein the nozzle is receivable in said fuel spout and engages said deflectable latch to allow said spring-loaded flapper valve to be deflected by the nozzle; and
a cover carried by said fuel spout, wherein removal of said cover allows receipt of the nozzle in said fuel spout.

2. The system according to claim 1, further comprising:
a shroud that surrounds said fuel spout; and
a tether connected at one end to said cover and at an opposite end to said shroud.

3. The system according to claim 1, further comprising:
an indicia collar that substantially surrounds said fuel spout and forming a gap therebetween, said cover fitting in said gap.

4. The system according to claim 3, wherein said cover comprises:
a body having an outer periphery; and
a flange extending from said outer periphery, said flange received in said gap.

5. The system according to claim 1, wherein said cover comprises:
a body having an outer periphery; and
a flange extending from said outer periphery, said flange fitting around said fuel spout.

6. The system according to claim 5, wherein said flange has an internal groove that receives an O-ring that seals around said fuel spout.

7. The system according to claim 6, wherein said flange has at least one external groove that receives an O-ring.

8. The system according to claim 7, further comprising:
a shroud that surrounds said fuel spout; and
a tether connected at one end to said cover and at an opposite end to said shroud.

9. The system according to claim 6, wherein said flange has at least one external groove that receives an O-ring.

10. The system according to claim 1, wherein said cover is disposed around said fuel spout but does not contact said deflectable latch, said spring-loaded flapper valve, or said linkage.

11. The system according to claim 1, where said cover only engages said fuel spout and no other component associated therewith.
